(19) United States
(12) Patent Application Publication
(10) Pub. No.: US 2022/0322649 A1
(43) Pub. Date: Oct. 13, 2022

(54) Large Marine Animal Automatic Release Device for Use with Deep Sea Fishing Gear

(71) Applicant: Little Bay Lobster, LLC, Newington, NH (US)

(72) Inventors: Todd Richard ELLIS, Somersworth, NH (US); Chad Mitchell GREENLAW, South Berwick, ME (US); Charles J. DONOVAN, Rollinsford, NH (US)

(73) Assignee: Little Bay Lobster, LLC, Newington, NH (US)

(21) Appl. No.: 17/348,091

(22) Filed: Jun. 15, 2021

Related U.S. Application Data
(60) Provisional application No. 63/173,833, filed on Apr. 12, 2021.

(51) Int. Cl. A01K 69/08; B63B 22/06

(52) U.S. Cl. CPC A01K 69/08; B63B 22/06; A01K 75/04

(57) ABSTRACT

A water pressure-activated end line severing device is configured to be attached to a lobster, crab or snow crab trawl end line and to automatically sever the end line if a large marine animal has snagged, bitten, seized, caught, become entangled with, or otherwise somehow attached itself to that end line. When any large marine animal, such as a whale, snags or becomes entangled in the end line, the normal, instinctive response of the large marine animal is to dive rapidly to a greater depth, which pulls the end line and the device attached to the end line to a greater depth in the water column. As the device descends to a greater depth in the water column, the water pressure exerted against the device rapidly increases. When the water pressure reaches and exceeds a predefined water pressure threshold, a trigger assembly on the device activates a spring-loaded cutter assembly, which forces movement of a cutting blade to sever the part of the end line that passes through an aperture in the device, thereby freeing the large marine animal from the end line and the weight of the lobster or crab trawl.

### FIELD OF THE INVENTION

Devices for automatically releasing large animals from sea fishing gear and, more particularly, devices that automatically sever end lines from lobster, crab and snow crab trap trawls.

### BACKGROUND OF THE INVENTION

In the commercial lobster, crab, and snow crab fishing industries, fishermen trap and catch live lobsters and crabs by dropping and leaving “trawls” along the ocean floor. A trawl comprises a number of individual traps that are connected (directly or indirectly) to a single rope line, referred to as a “ground line.” A trawl can be up to a mile or more long, and can have anywhere from 1 to 50, or even more, individual traps connected to it. The traps in a trawl are typically constructed from plastic coated steel wire. Typically, but not necessarily, trawls are dropped in ocean waters that are up to thirteen hundred or more feet in depth. Fishermen use winches attached to their boats to lower trawls into the water as the boat moves across the ocean's surface, and the trawls sink immediately to the ocean floor, where they typically end up lying in a relatively horizontal line (not necessarily a straight line) along the ocean floor.

The two ends of the ground line of a trawls are attached, respectively, to two ropes, commonly referred to as “end lines,” which extend vertically from the ground line on the floor of the ocean to the surface of the ocean. In addition to being attached to the ground line, the lower ends of the two end lines are also anchored to the ocean floor by weights. Therefore, trawls can be, and usually are, extremely heavy, depending on the number of traps and the number of weights attached to the ground line.

To help the fishermen find the trawls they have left in deep waters, the upper ends of the two end lines are connected to two or more “polyballs,” respectively. The polyballs, which are large, air-filled balls that are approximately 50 inches in diameter, float on the top of the surface of the water. The polyballs and end lines are frequently connected to “high flyers,” comprising a metal pole, a flag and a radar reflector. Together, the polyballs and high flyers serve as highly visible and/or detectable markers that indicate the locations of the trawls lying beneath the surface of the water, as well as the relatively vertical end lines extending from the polyballs down to the trawls. The polyballs and high flyers also serve to mark out the surrounding area as a fishing territory that is already claimed by a particular fisherman or a particular fishing company.

Once they are dropped to the floor of the ocean, lobster and crab trawls are usually left in the same general location indefinitely. The only time they are moved is when the trawls are being hauled out of the water to remove the lobsters and crabs from the traps. When all the lobsters and crabs are removed from the traps, the trawls “reset” and dropped in substantially the same place. Occasionally, when lobsters or crabs are moving from one location to another during the course of the year, an individual trawl may be pulled up and transported on the deck of the boat to a new location, where the trawl is to be deposited back in the ocean and left indefinitely.

After dropping a trawl into the ocean, the fishermen typically leave the area to go haul and reset trawls in other locations, or to go back to their home docks. The fishermen usually do not return to haul and reset a trawl for four or five days. But if the fishing is really good, the fishermen may return in as little as 24 hours. In either case, however, the trawl and the end lines connected to the trawls always remain in the ocean. They are rarely, if ever, removed from the ocean. While the fisherman are absent, due to prevailing water currents, the polyballs, high flyers and connected end lines can end up floating up to a mile or more away from the location where they were initially dropped, despite the heavy weight of the trawls to which they are connected.

Unfortunately, large marine animals, such as whales, sharks and sea turtles, sometimes get themselves tangled and caught in the end lines. These entanglements can occur if the sea animal mouths an end line or gets a fin, tail or other appendage caught on an end line, especially if the marine animal dives, rotates or spins in the water after making contact with the end line. Not surprisingly, entanglement can cause long-term adverse health effects, even for large marine animals that eventually manage to escape the end lines. In some situations, large marine animals that get tangled in end lines can end up dragging the heavy trawls around in the ocean for hours, days, weeks, or even months, until the animal eventually dies, loses an appendage or somehow becomes untangled. When there are many trawls in the water, the ramifications of such entanglements can be both enormous and tragic, especially if the marine animals involved are on the endangered species list. It is a known fact, for example, that chronic entanglement in deep sea lobster fishing gear is a known source of extreme stress, pain, and suffering for right whales, and can interfere with their eating, moving, and reproductive health. According to Earthjustice, a nonprofit environmental law organization, and the Conservation Law Foundation (CLF), research shows that entanglement in fishing gear has accounted for 85 percent of right whale deaths in recent years.

Accordingly, there is considerable need in the commercial lobster and crab fisheries for a device that will automatically sever the end lines connected to trawls when a large marine animal, such as a right whale, comes into contact with, catches, or otherwise becomes entangled in, one or more trawl end lines. If a large number of lobster and crab fishermen used such a device on a regular basis, it would undoubtedly help a large number of marine animals avoid severe entanglement, injury or death.

### SUMMARY OF THE INVENTION

Embodiments of the present invention provide a water pressure-activated end line severing device, which shall hereinafter be referred to in this disclosure as the “Todd Device.” The Todd Device is configured to be attached to a lobster or crab trawl end line and to automatically sever the end line if the Todd Device is displaced in the water column in such a manner that indicates that a large marine animal has snagged, bitten, seized, caught, become entangled with, or otherwise somehow attached itself to that end line. For purposes of this disclosure, “large marine animal” refers to a whale, a dolphin, a shark, a manatee, a walrus, or any other relatively large aquatic animal, regardless of whether the animal lives in the ocean, lake or river, and regardless of whether the animal is more likely to be found in salt water or fresh water. When any large marine animal snags or becomes entangled in the end line, the normal, instinctive response of the large marine animal is to dive rapidly to a greater depth (depth being measured from the water's surface). When this happens, the rapid descent of the large marine animal will pull the end line, as well as the Todd Device attached to the end line, to a greater depth in the water column. The Todd Device will be pulled to a greater depth regardless of whether the large marine animal first comes into contact with the end line above or below the point on the end line where the Todd Device is attached. As the Todd Device descends to a greater depth in the water column, the water pressure exerted against the Todd Device rapidly increases. When the water pressure reaches and exceeds a predefined water pressure threshold, the increased water pressure automatically activates a trigger assembly on the Todd Device, which in turn activates a spring-loaded cutter assembly, which moves a cutting blade to sever the part of the end line that passes through an aperture in the Todd Device.

The automatic cutting of the end line by the Todd Device causes the lower portion of the end line (i.e., the portion of the end line extending from the attached Todd Device to the ground line of the connected trawl) to be severed from the upper portion of the end line (i.e., the portion of the end line extending from the Todd Device to the polyball(s) floating on the surface of the ocean). Importantly, when the end line is severed by the Todd Device, the lower portion of the end line, which is still connected to the heavy trawl, as well as the Todd Device itself, sinks harmlessly to the sea floor, thereby freeing the large marine animal from the weight of the heavy trawl, and thus avoiding a very dangerous situation in which the large marine animal is forced to drag (or attempt to drag) the heavy trawl behind it as it tries desperately to free itself from the end line. Even if the end line somehow stays attached to the large marine animal, the drag exerted on the movements of the large marine animal will be relatively minor when compared to the drag that would have resulted if the trawl was still connected to the end line. Notably, in the very unlikely case of portion of the end line connected to the polyballs and high flyer remains attached to the large marine animal after the Todd Device has severed the end line, the drag exerted on the large marine animal due to the polyballs and high flyer is usually so small, relative to the size and strength of the large marine animal, that it does not pose a serious risk of injury or death to the large marine animal.

Because the automatic cutting of the end line to disconnect the trawl if the end line is snagged or entangled happens substantially simultaneously with change in depth, it also significantly reduces, and potentially eliminates, any chance that the large marine animal will either be killed or sustain severe injuries as a result of the entanglement, the Todd Device complies with the intent of Endangered Species Act (ESA) of 1973 in regards to conserving and protecting the health and lives of endangered and threatened species, such as northern right whales.

In general, pressure-activated end line severing devices constructed in accordance with embodiments of the present invention comprise a cutter assembly and a trigger assembly. In preferred embodiments, the Todd Device is activated by an increase in water pressure exerted against the trigger assembly. The increased water pressure causes a rapid withdrawal of a rod extending from the bottom of the trigger assembly and into the top of the cutter assembly. The rapid extraction of the rod moves a latch in the cutter assembly to release compression on a double set of springs. The release of the compressed set of springs in the cutter assembly forces a cutting edge or blade to sever the end line that passes through an aperture in the cutter assembly rapidly and with enormous force.

In practice, the Todd Device is normally affixed to both end lines of a trawl. It is effective in depths between 20 and 1,300 feet (or greater). The device is activated by the water-pressure activated trigger assembly, which releases a stainless-steel cutting blade powered by a multiplex, integrated spring-loaded mechanism configured to deploy with sufficient force to cut completely through the end line that connects a lobster or crab trawl lying on the seabed to the polyballs and highfliers floating on the water's surface. The sizes and shapes of the cutting blade, aperture and compression springs may be selected and arranged based on the type and diameter of the rope used for the end lines. In some cases, the rope will be ⅝ inches thick. However, the end line rope could be thicker or thinner, depending on a variety of commercial fishing factors.

Thus, embodiments of the present invention provide a device for automatically severing a rope line that ties a marker floating on or near the surface of a body of water to underwater fishing gear located below the surface of the body of water. The device comprises a cutter assembly and a trigger assembly. The cutter assembly comprises an aperture and a rope line latch for attaching the device to a segment of the rope line, and a spring-loaded blade assembly comprising a blade, a blade holder that holds the blade in a position that is directly adjacent to the aperture, and a set of loaded springs connected to the blade holder. The set of loaded springs are configured to urge the blade holder and the blade to move in a direction that causes the blade held by the blade holder to pass through the aperture if the load in the set of loaded springs is released. The load on the set of loaded springs may be imparted either by compressing or stretching the coils in the set of loaded springs. The cutter assembly also includes a receiving slot in the blade holder. The receiving slot is configured to receive a first end of a piston rod that, while inserted in the receiving slot, prevents movement of the blade holder and thereby prevents the release of the load in the set of loaded springs. The compression (or stretching) of the set of loaded springs puts a large shear force on the first end of the piston rod, which holds the first end of the piston rod in place due to the friction.

The trigger assembly, which is attached to the top of the cutter assembly, comprises a cylinder and a piston. The opposite end of the piston rod that is inserted into the receiving slot of the cutter assembly comprises part of the piston in the trigger assembly. The piston also comprises a piston skirt located within an internal chamber of the cylinder. The piston skirt is connected to the opposite end of the piston rod (opposite from first end of the piston rod inserted into the receiving slot of the cutter assembly). When the device passes below a predefined depth in the body of water, the resulting increase in water pressure on the internal chamber of the cylinder of the trigger assembly will force the piston skirt and the opposite end of the piston rod connected to the piston skirt to move away from the side of the trigger assembly adjacent to the cutter assembly. Because the piston skirt is mechanically connected to the piston rod, the movement of the piston skirt pulls the first end of the piston rod out of the receiving slot in the cutter assembly and releasing the load on the set of loaded springs. The releasing of the load on the set of loaded springs immediately causes the blade holder and the blade to move (typically very rapidly) in the direction that causes the blade held by the blade holder to pass through the aperture and sever the section of the rope line secured in the aperture by the rope latch. The predefined depth (i.e., the depth below the surface of the body of water that the trigger assembly will be activated) may be set by controlling the cross-sectional size (i.e., the volume) of the internal chamber of the cylinder on the trigger assembly.

To load the device, the end of the piston rod extending from the bottom of the trigger assembly is inserted into receiving slot in the top clamshell of the cutting assembly. Then, the springs in the cutting assembly that push against the blade holder in the cutting assembly are compressed (or stretched in some embodiments), which puts a large shear force on the end of the piston rod inserted into the receiving slot. The internal chamber of the cylinder in the trigger assembly is divided into two spaces separated by the piston skirt, the first space containing the piston rod and water inlets, the second space containing air at ambient pressure. The force required to displace the piston skirt a sufficient distance to pull the piston rod connected to the piston skirt from the receiving slot of the cutter assembly may be referred to as the triggering force for the device. When the device is put into a body of water, such as the ocean, for example, ocean water passes into the first space in the internal chamber through the water inlets. The water in the first space of the internal chamber pushes on the piston skirt, thereby increasing the pressure on the second space of the internal chamber containing the air. As the device sinks into the ocean, this pressure on the second space in the internal chamber containing the air increases dramatically as more water passes into the first space of the internal chamber containing the water inlets. When the water pressure against the piston skirt equals the triggering force (this occurs at a certain predefined target depth), the water pressure causes the piston skirt to move toward the space in the internal chamber containing the air, thereby compressing the air behind the piston skirt. As the piston skirt moves, it pulls the connected piston rod out of the receiving slot in the cutter assembly, releasing the blade holder and blade to sever the section of the end line passing through the aperture in the cutter assembly. Ideally, the internal chamber of the cylinder is configured, in terms of its dimensions, so that even small displacements of the piston skirt in the internal chamber of the cylinder as the device moves to greater depths causes a significant amount of pressure to build in the internal cylinder. Typically, the opposing force from the compressed air on one side of the piston skirt inside the internal chamber of the cylinder is very small in comparison to the force from the ocean water entering the internal chamber on the opposite side of the piston skirt.

### BRIEF DESCRIPTION OF THE DRAWINGS

The present invention and various aspects, features and advantages thereof are explained in detail below with reference to exemplary, and therefore non-limiting, embodiments and with the aid of the drawings, which constitute a part of this specification and include depictions of the exemplary embodiments. In these drawings:

FIG. 1 shows a top, frontside and right side perspective view of a Todd Device constructed according to one embodiment of the present invention.

FIG. 2A shows a top and front side perspective view of the Todd Device.

FIG. 2B shows a top view of the Todd Device.

FIG. 2C shows a top and rear side perspective view of the Todd Device.

FIG. 2D shows a closer view of the aperture, the rope latch and the sliding rope latch pin of the Todd Device.

FIGS. 3A, 3B, 3C, 3D and 3E show, respectively, a left side view, a topside view, a right side view, a cross-sectioned view, and a topside, rear and right side perspective view of the bottom clamshell of the cutter assembly of the Todd Device according to one embodiment of the present invention.

FIGS. 4A, 4B, 4C, 4D, 4E, 4F and 4G show, respectively, a right side view, a bottom side view, a left side view, a front elevation view, a bottom, rear and left side perspective view, a topside view and a cross-sectioned view of the top clamshell of the cutter assembly of the Todd Device according to one embodiment of the present invention.

FIGS. 5A, 5B, 5C and 5D show, respectively, a left side elevation view, a front side elevation view, a right side elevation view, and a top, right and rear perspective view of the blade spring press plate of the cutter assembly of the Todd Device according to an embodiment of the present invention.

FIGS. 6A, 6B and 6C show, respectively, a left side elevation view, a front side elevation view and a right side elevation view of the rope latch spring press plate of the cutter assembly of the Todd Device according to an embodiment of the present invention.

FIG. 7 shows, by way of example, how the cutter assembly of the Todd Device is attached to an end line in some embodiments of the present invention.

FIGS. 8A and 8B show, respectively, a perspective view and a right side view of the cutter assembly with the top clamshell removed in order to illustrate the internal components of the cutter assembly of the Todd Device according to some embodiments of the present invention.

FIGS. 9A, 9B, 9C, 9D and 9E show, respectively, a frontside view, a cross-sectioned view, a left side view, a topside view and a right side view of the rope latch of the cutter assembly of the Todd Device according to some embodiments of the present invention.

FIGS. 10A, 10B, 10C, 10D and 10E show, respectively, a left side view, a bottom side view, a right side view, a perspective view and a rear side view of the blade holder of the cutter assembly of the Todd Device according to some embodiments of the present invention.

FIGS. 11A, 11B, 11C and 11D show, respectively, a left side view, a top side view, a right side view and a frontside of the blade holder of the cutter assembly of the Todd Device.

FIGS. 12A and 12B show, respectively, a top side view and a right side view of the blade handle of the cutter assembly of a Todd Device constructed in accordance with one embodiment of the present invention.

FIG. 13 shows, by way of example, a typical configuration for the blade held by the blade handle of the cutter assembly of the Todd Device in accordance with embodiments of the present invention.

FIGS. 14A, 14B, 14C, 14D, and 14E show, respectively, a bottom side view, a left side view, a topside view, a cross-sectioned view and a perspective view of the trigger assembly of the Todd Device 1.

FIGS. 15, 16 and 17 show schematic diagrams to illustrate how the Todd Device is normally deployed and operated to liberate a whale entangled in an end line attached to a trawl in the ocean.

### DETAILED DESCRIPTION OF EXEMPLARY EMBODIMENTS

An exemplary Todd Device according to embodiments of the present invention will now be described in more detail with reference to the figures. Some of the figures show computer-aided drawings (CAD) of exemplary versions of the Todd Device. Generally speaking, lobster, snow crab and crab trawl end lines have diameters that are typically between about ½ and ⅝ths of an inch. Snow crab trawl end lines are typically ¾ in. or greater in diameter. However, it will be apparent to those skilled in the art and familiar with lobster and crab fishing that embodiments of the Todd Device of the present invention may be beneficially constructed in a variety of different sizes and dimensions, depending on a variety of different factors, including the diameters of the end lines that need to be severed, the type of water body where the device will be used, as well as depths at which the devices are intended to be used. Therefore, it will be apparent that larger or smaller versions of the Todd Device, as well as Todd Devices having larger or smaller subcomponents, may be constructed and beneficially used without departing from the scope and spirit of the invention that is claimed.

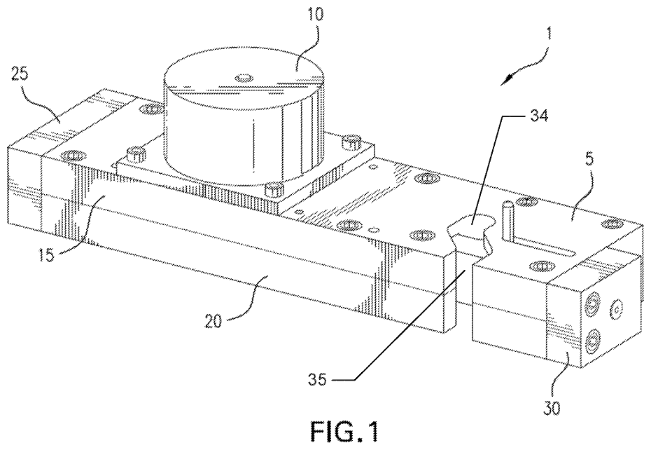

Turning now to the figures, FIG. 1 shows, by way of example, a topside, frontside and right side perspective view of one example of a Todd Device 1 constructed according to one embodiment of the present invention. As shown in FIG. 1, the Todd Device 1 comprises a cutter assembly 5 and a trigger assembly 10. The cutter assembly 5 comprises a top clamshell 15 and a bottom clamshell 20, which may be bolted, screwed or glued together with bolts, with screws or with glue to define an airtight enclosure that surrounds, encapsulates and protects the internal components (described in more detail below) of the cutter assembly 5. The airtight enclosure helps protect the Todd Device 1 from damage resulting from it being used in salt water environments. The cutter assembly 5 also comprises a blade spring press plate 25 (located on the left end of the cutter assembly 5 shown in FIG. 1), and a rope latch spring press plate 30 (located on the right side of the cutter assembly 5 shown in FIG. 1).

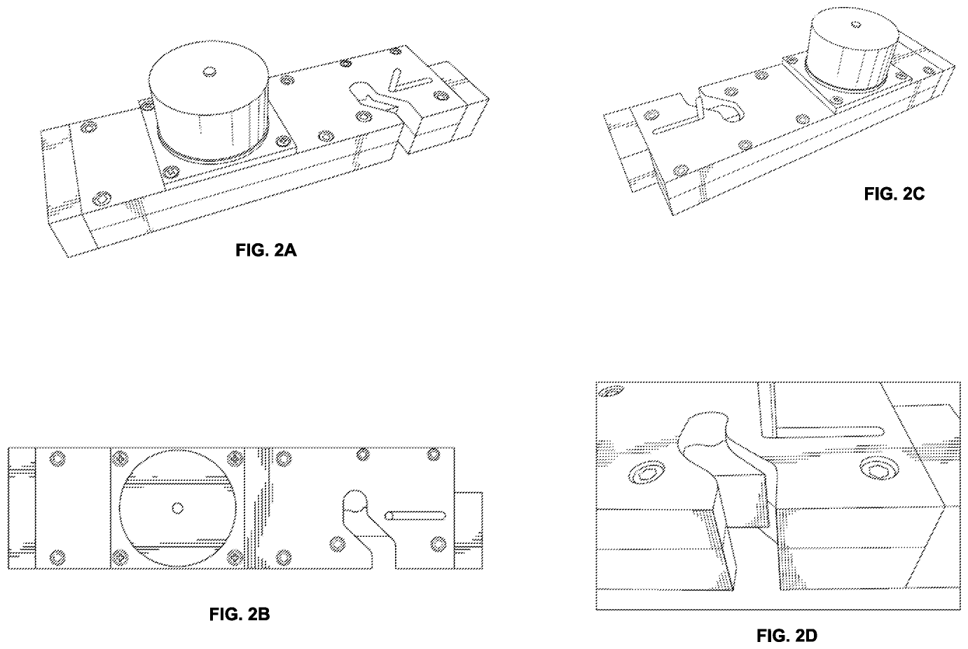

FIGS. 2A, 2B, 2C and 2D show, respectively, a top and front side perspective view, a top view, a top and rear side perspective view, and a close up view of the aperture, the rope latch and the sliding rope latch pin of the Todd Device.

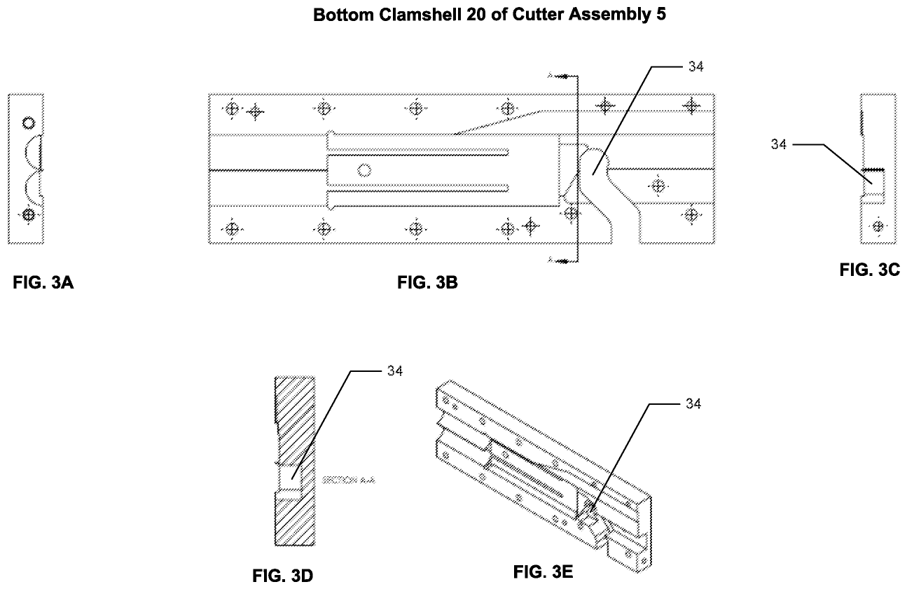

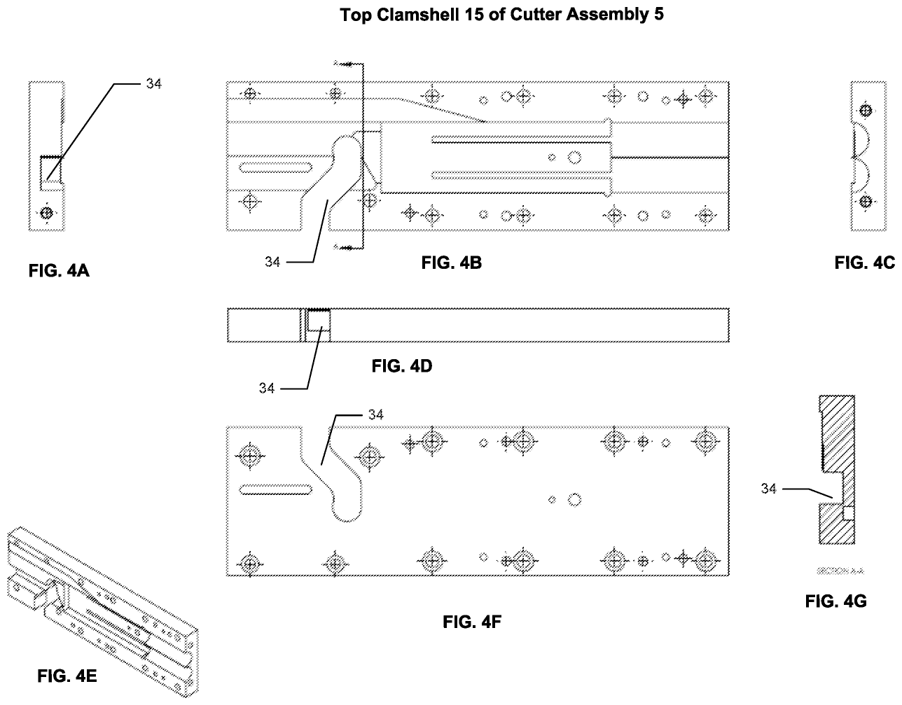

FIGS. 3A, 3B, 3C, 3D and 3E show, respectively, a left side view, a topside view, a right side view, a cross-sectioned view, and a topside, rear and right side perspective view of the bottom clamshell 20 of the cutter assembly 5 of the Todd Device. FIGS. 4A, 4B, 4C, 4D, 4E, 4F and 4G show, respectively, a right side view, a bottom view, a left side view, a front elevation view, a bottom, rear and left side perspective view, a top view and a cross-sectioned view of the top clamshell 15 of the cutter assembly 5 of the Todd Device 1. As shown best in FIGS. 3B, 3C, 3D, 3E, 4A, 4B, 4D, 4E, 4F and 4G, portions of both the bottom clamshell 20 and the top clamshell 15 of the cutter assembly 5 contain cutouts that together define an aperture 34 that extends from the top surface of the top clamshell 15 and all the way through to the bottom surface of the bottom clamshell 20 of the cutter assembly 5. This aperture 34 is configured to be wide enough to pass an end line therethrough, wherein the diameter of the end line may vary depending on the requirements of the particular trawls to which the end line will be attached.

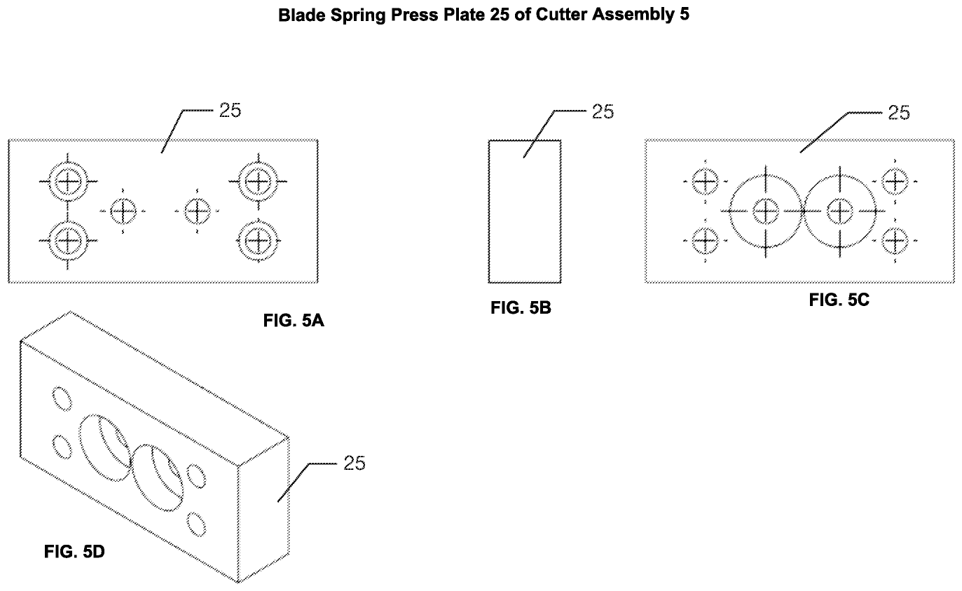

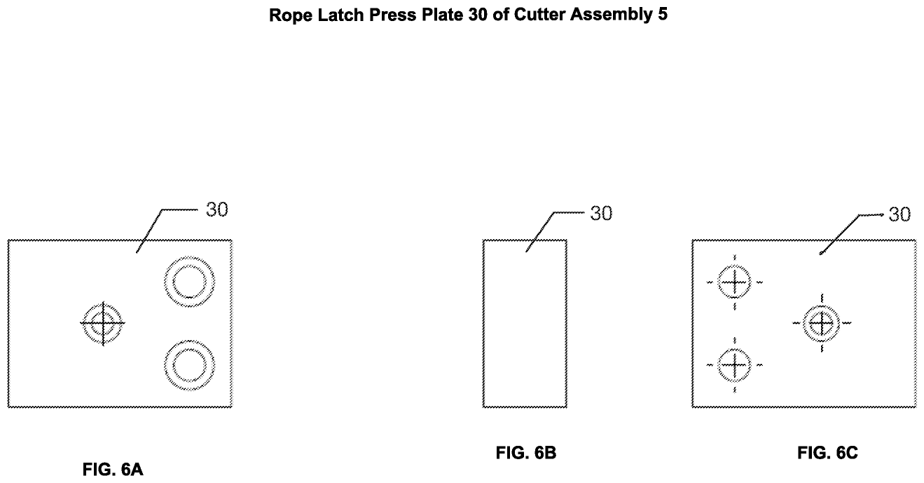

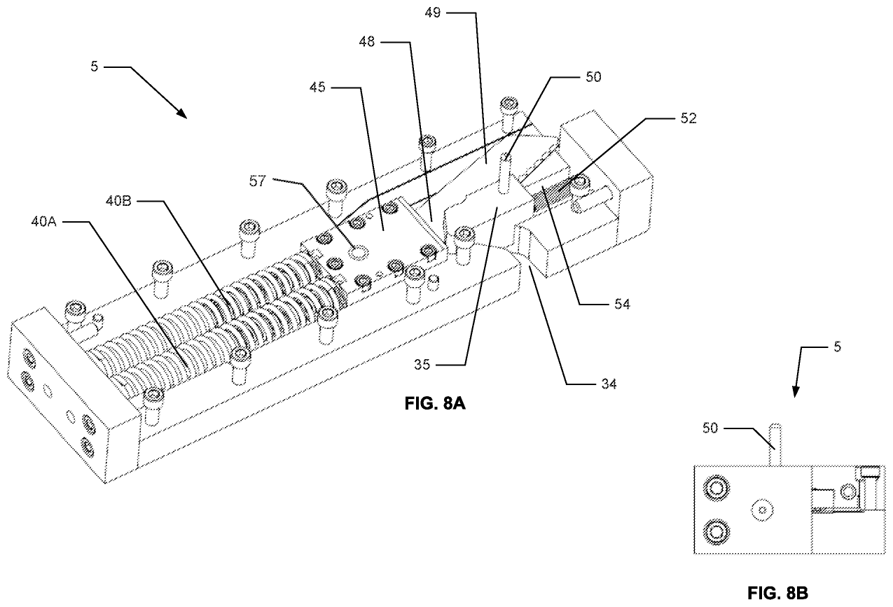

FIGS. 5A, 5B, 5C and 5D show, respectively, a left side elevation view, a frontside elevation view, a right side elevation view, and a topside, right and rear perspective view of the blade spring press plate 25 of the cutter assembly 5 of the Todd Device 1. FIGS. 6A, 6B and 6C show, respectively, a left side elevation view, a frontside elevation view and a right side elevation view of the rope latch spring press plate 30 of the cutter assembly 5 of the Todd Device 1. The blade spring press plate 25 and the rope latch spring press plate 30 provide substantially immovable structural support for a set of internal spring mechanisms (discussed in more detail below and with reference to FIGS. 8A and 8B), as well as seal reinforcing elements for the seal between the top clamshell 15 and the bottom clamshell 20 of the cutter assembly 5.

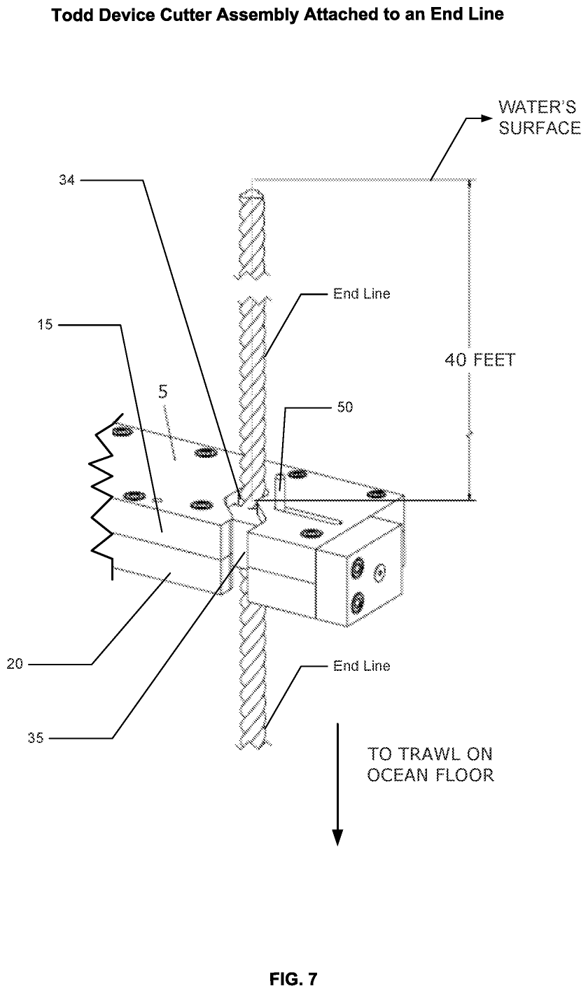

FIG. 7 illustrates how the Todd Device 1 is attached to an end line in some embodiments of the present invention. As shown in FIG. 7, the end line passes through the aperture 34 that extends from the top surface of the top clamshell 15 to the bottom surface of the bottom clamshell 20 of the cutter assembly 5. The end line is held tight against the inner walls of the aperture 34 by a rope latch 35. A sliding rope latch pin 50 extends from the top of the cutter assembly 5 is operable to open, close and lock the rope latch 35 in place inside the aperture.

FIGS. 8A and 8B show, respectively, a perspective view and a right side view of the cutter assembly 5 with the top clamshell 15 removed in order to show the internal components of the cutter assembly 5. As shown in FIG. 7A, the cutter assembly 5 comprises a multiplicity of internal cavities configured to receive and house two banks 40A and 40B of nested springs under compression, a blade holder 45, a blade handle 48, the rope latch 35, the sliding rope latch pin 50, a compression spring 52 and a compression spring guide 54. Each one of the two banks 40A and 40B of nested springs comprises a spring within a spring, so that, when they are released from compression they will decompress with enough force and sufficient torque to force the blade 49 to instantaneously sever a ⅝″ polyethylene commercial grade line (end line) connecting the heavy trawl gear (traps) on the ocean bed to the polyballs and high flyers floating on the ocean's surface. Typically, the blade 49 is ¾″ in length, and is preferably made of tempered stainless steel so that the blade 49 will be rust proof and impervious to saltwater oxidation and dulling.

The spring banks 40A and 40B each comprises an inner loaded spring nested inside an outer loaded spring. In some embodiments, the inner loaded spring has a central axis that is coextensive with the central axis of the outer loaded spring. The spring banks 40A and 40B may be reset to the “loaded” position if the Todd Device 1 has been previously activated and the blade 49 has been previously sprung. Consequently, the Todd Device is reusable.

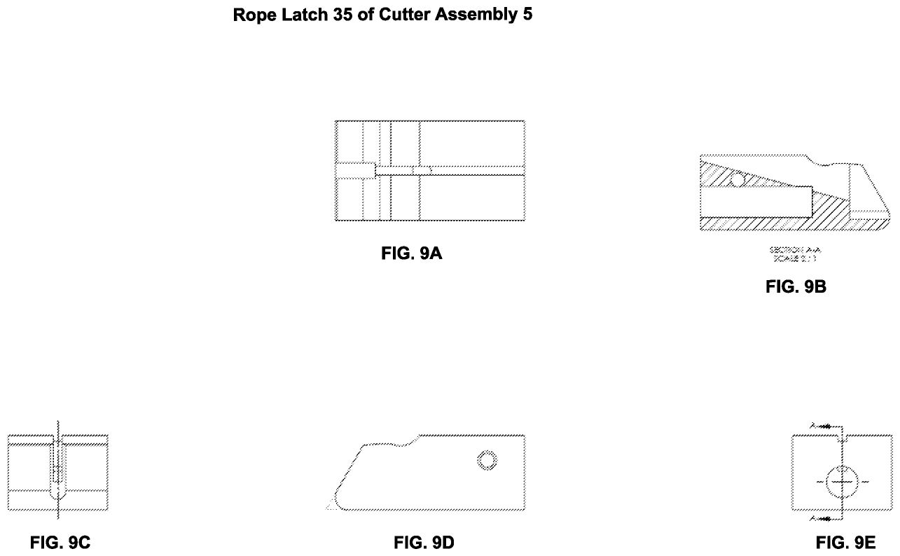

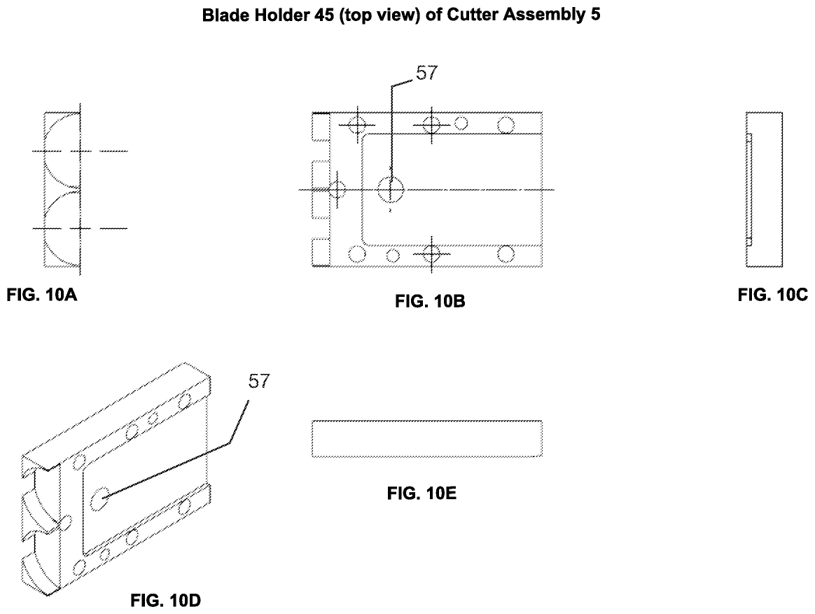

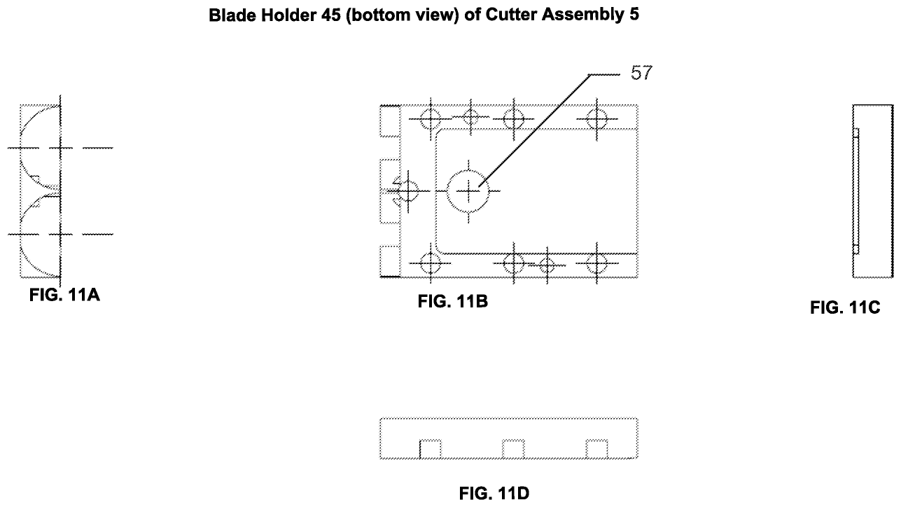

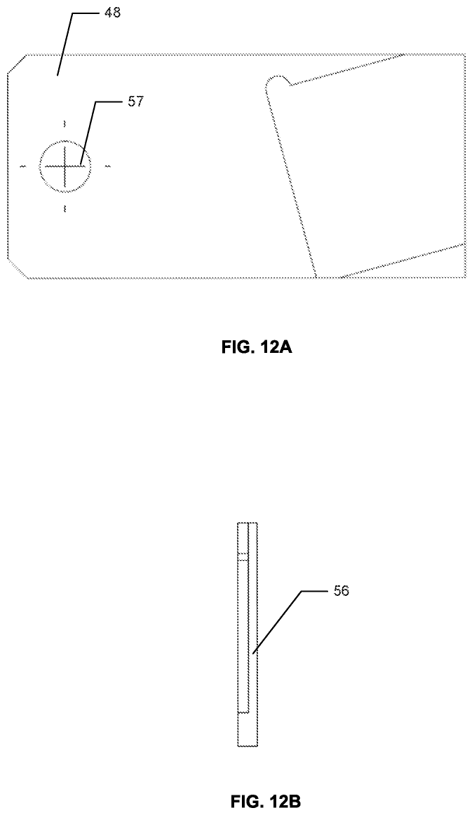

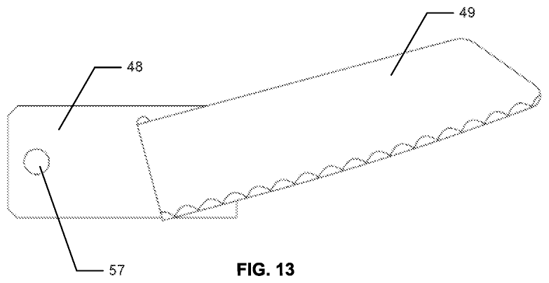

FIGS. 9A, 9B, 9C, 9E and 9E show, respectively, a frontside view, a cross-sectioned view, a left side view, a topside view and a right side view of the rope latch 35 of the cutter assembly 5 of the Todd Device 1. FIGS. 10A, 10B, 10C, 10D and 10E show, respectively, a left side view, a bottom side view, a right side view, a perspective view and a frontside of the blade holder 45 of the cutter assembly 5 of the Todd Device 1. FIGS. 11A, 11B, 11C and 11D show, respectively, a left side view, a top side view, a right side view and a frontside of the blade holder 45 of the cutter assembly of the Todd Device. The blade holder 45 holds a blade handle 48, which in turn holds the blade 49 of the cutter assembly 5. FIGS. 12A and 12B show, respectively, a top side view and a right side view of the blade handle 48 of the cutter assembly 5 of the Todd Device 1. FIG. 13 shows, by way of example, the a useful configuration of the blade 49 held by the blade handle 48. The blade handle 48 and the blade 49 may sometimes be referred to collectively as a blade assembly.

Both the blade holder 45 and the blade handle 48 include a slot 57 configured to receive one end of a piston rod 62 extending from the trigger assembly 10 affixed to the top of the cutter assembly 5. The insertion of the piston rod 62 into the slot 57 of the blade holder 45 and the blade handle 48 prevents the two banks 40A and 40B of nested springs under compression from decompressing, which prevents the blade handle 48 and the blade 49 from snapping forward as a result of the forces applied by the two banks 40A and 4B of nested springs under compression. When the piston rod 62 is retracted from the slot 57, however, the two banks 40A and 40B will rapidly decompress, which causes the blade handle 48 and the blade 49 to snap forward and cut the end line.

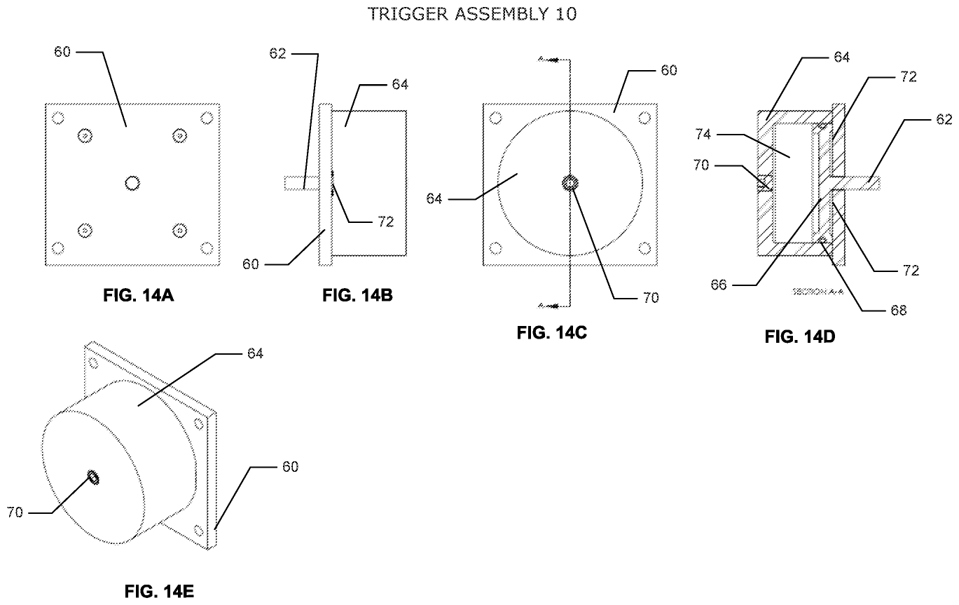

FIGS. 14A, 14B, 14C, 14D and 14E show, respectively, a bottom side view, a left side view, a topside view, a cross-sectioned view and a perspective view of the trigger assembly 10 of the Todd Device 1. As shown in these figures, the trigger assembly 10 comprises a base plate 60, a piston rod 62, a cylinder 64, a piston skirt 66 inside the housing 64, an O-ring 68 positioned around the perimeter of the piston skirt 66, and a plug 70 in the top of the cylinder 64. Typically, the trigger assembly 10 will be removably bolted or screwed to the top of the cutter assembly 5 such that the piston rod 62 will extend through the top clamshell 15 of the cutter assembly 5 to be received by a hole in the blade holder 45. The cylinder 64 further comprises one or more water inlets 72, which permit water to enter the cylinder at a rate proportional to the water pressure exerted on the trigger assembly 10. Preferably, but not necessarily, the water inlets 72 of the trigger assembly 10 are calibrated to the water density in the mapped area of intended use. On the side of the piston skirt 66 that is opposite from the piston rod 62, there is an internal chamber 74, which is initially filled with air.

When a large marine animal, such as a whale, comes into contact with an end line passing through the Todd Device, the large marine animal will typically dive to a greater depth in the water column. The dive pulls the Todd Device to a greater depth in the water column. As the Todd Device 1 is pulled to a greater depth in the water column, the water pressure exerted on the trigger assembly increases dramatically. The dramatic increase in water pressure on the trigger assembly causes water to pass rapidly through the water inlets 72 and fill the internal chamber 74 of the cylinder 64, which causes the piston skirt 66 to push the air out of the internal chamber 74 of the cylinder 64 through the plug 70. As the air exits the internal chamber 74 of the cylinder 64, the piston skirt 66 rapidly moves toward the plug 70 inside the cylinder 64. When the piston skirt 66 moves rapidly toward the plug 74, it pulls the piston rod 62 along with it, thereby causing the piston rod 62 to retract into the trigger assembly 10 at a rapid rate of speed. The rapid displacement and evacuation of the piston rod 62 out of the blade holder 45 of the cutter assembly 5 releases the compression on the springs in the spring banks 40A and 40B of the cutter assembly 5, which causes the blade holder 45 to snap forward with enough force to cause the blade 49 to snap forward at a high rate of speed. This rapid movement of the blade 49 completely severs the end line passing through the cutter assembly 5, thereby breaking the physical connection between the trawl on the seabed and the polyballs on the surface of the water.

The trigger assembly 10 typically has an effective useable range of depths between 20 and 1,500 feet. Preferably, the trigger assembly 10 is factory preset to activate at a predefined depth in the water column and has a plus/minus variance of 1.5 to 3.5 meters in terms of release point in the water column. A variety of different sized trigger assemblies 10 may be manufactured to fit the same cutter assembly, depending on the desired predefined activation depth.

In preferred embodiments, the trigger assembly 10 on the Todd Device 1 can be set to trigger at any depth in the water column deemed to be most appropriate, taking into account presumed characteristics of the marine animals most likely inhabiting the area or fishing zone. The depth of activation is determined by controlling the cross-sectional size of the internal chamber 74 of the cylinder 64 in the trigger assembly 10. More specifically, the predefined depth (i.e., the depth below the surface of the body of water that the trigger assembly will be activated) may be set by controlling the cross-sectional size (i.e., the internal volume) of the internal chamber 74 of the cylinder 64 on the trigger assembly 10. The larger the cross-section of the internal chamber 74 of the cylinder 64 on the trigger assembly 10, the shallower the depth that the water needs to be for trigger assembly 10 to be activated by the water pressure exerted on the internal chamber 74. Conversely, the smaller the cross-sectional size of the internal chamber 74 of the cylinder 64 of the trigger assembly 10, the deeper the depth of the water needs to be for the trigger assembly 10 to be activated. This is because, as compared to a smaller internal chamber, a larger internal chamber will undergo a greater amount of force of water pressure than a smaller internal chamber located at the same depth in the water column.

For example, in one embodiment of the Todd device 1, wherein the device is intended to automatically sever the rope line at a predefined depth of about 40 feet below the surface of the water, the internal chamber 74 in the cylinder 64 on the trigger assembly 10 should be constructed to have a height of about 22.3 mm (0.878 inches) and an internal diameter of about 61.3 mm (2.4134 inches). However, it will be appreciated by those skilled in the art that a version of the Todd device 1 that is intended to automatically sever the rope line at say, 400, 800 or 1000 feet below the surface of the water will necessarily have relatively smaller internal chambers (and thus smaller cylinders) on their trigger assemblies, depending on the desired activation depths.

The diameter of the piston skirt in the internal chamber of the cylinder required to trigger the device at a target depth may be calculated as follows:

Required Diameter=Triggering Force/Water Pressure(P_{W})at Target Depth,

wherein,

P_{W}=Water Density*Force of Gravity*Target Depth

Table 1 below shows, by way of example, the required diameters (calculated in accordance with the above formula) for the piston skirts and internal chambers of the cylinders for seven different desired target depths for one version of the Todd device having a triggering force of 80 lbs. (or 355.8 Newtons) in ocean water having a density of 1.23.6 kg/m³.

TABLE 1
Piston Skirt Diameter Calculations Based
on Seven Exemplary Desired Target Depths

| | | Water | Required Piston | |
|---|---|---|---|---|
| | Desired | Pressure at | Skirt Area | Required Piston |
| Example | Target Depth | Target Depth | (sq inches/ | Skirt Diameter |
| No. | (feet/meters) | (PSI/Pascals) | sq millimeters) | (inches/meters) |
| 1 | 100/30.5 | 44.3/305,753.4 | 1.804/1163.814 | 1.516/0.038 |
| 2 | 250/76.2 | 110.8/764,383.5 | 0.722/465.5255 | 0.959/0.024 |
| 3 | 500/152.4 | 221.7/1,528,767 | 0.361/232.7627 | 0.678/0.17 |
| 4 | 800/243.8 | 354.7/2,446,027 | 0.225/145.4767 | 0.536/0.014 |
| 5 | 1200/365.8 | 532/3,669,041 | 0.150/96.98447 | 0.437/0.011 |
| 6 | 1500/457.2 | 665/4,586,301 | 0.120/77.58758 | 0.391/0.010 |
| 7 | 3000/914.4 | 1330/9,172,602 | 0.060/38.79379 | 0.277/0.007 |

Accordingly, in preferred embodiments of the invention, the diameter of the piston skirt on the piston inside the internal chamber of the cylinder 64 on the trigger assembly (and thus the size of the trigger assembly itself) may be selected according to the desired target depth that the user wishes for the trigger assembly 10 to be activated by water pressure to automatically sever the rope line. Moreover, the triggering assemblies and cutter assemblies may be manufactured in a variety of different sizes and configurations, and may be built to be interchangeable based on the particular environment or fishing application. For example, a triggering assembly configured to activate at a particular threshold depth (say, 50 feet) can be removed from the cutter assembly and replaced with a triggering assembly configured to activate at a different threshold depth (say, 250 feet) if the situation calls for it. Alternatively, embodiments of the Todd device of the present invention may be manufactured so that, for safety reasons, end users cannot remove the trigger assemblies from the cutter assemblies, but the trigger assemblies have been pre-selected at the factory, in terms of their size, so that end users can select the Todd device that already has on it a trigger assembly with the appropriate size to activate the cutting assembly at the desired depth.

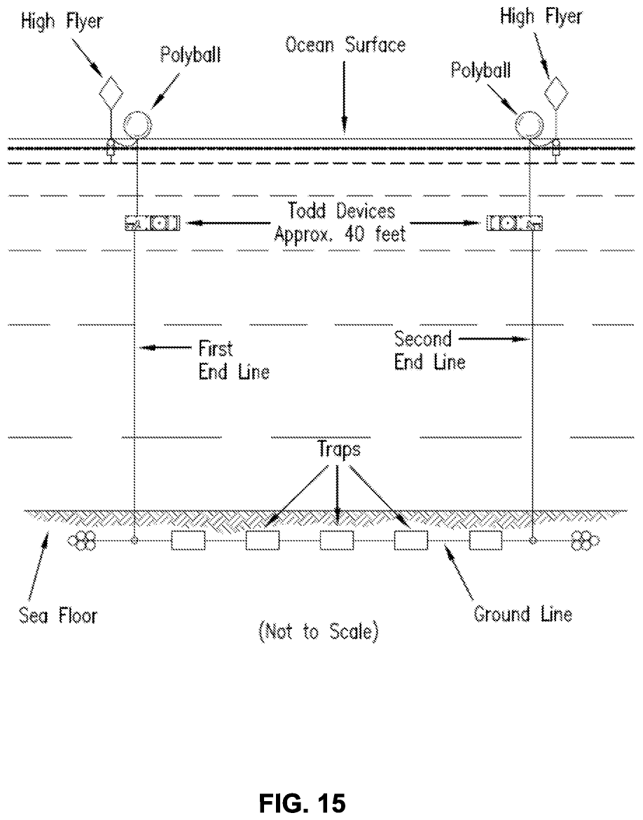

FIGS. 15, 16 and 17 contain high-level sketches that show, respectively, how the Todd Device 1 is normally deployed and operated to liberate a whale entangled in an end line attached to a trawl in the ocean. More specifically, FIGS. 15, 16 and 17 show the Todd Device 1 and a typical operating environment, i.e., the relevant water column, before, during and after activation of the trigger assembly 10 caused by entanglement of a whale. Note that, in order to improve comprehension for the reader, none of the elements in the three sketches are drawn to proper scale. In reality, the high flyers, polyballs, end lines, trawls and Todd Device are miniscule when compared to the size of the whale.

The Todd Device 1 is configured to be attached to an end line before the end line is placed into the water. This may be accomplished operating the sliding rope latch pin 50 in the cutter assembly 5 to open the rope latch 35 so that a section of the end line may be pushed to the back walls of the aperture 34. After the end line is positioned in the aperture 34, the sliding rope latch pin 50 is operated again to lock the rope latch 35 over the end line, which secures the Todd Device 1 to the end line. Then the end line, the Todd Device 1 and the trawl may be dropped into the water so that the trawl will sink to the sea floor and the end line extends from the sea floor to the surface of the water.

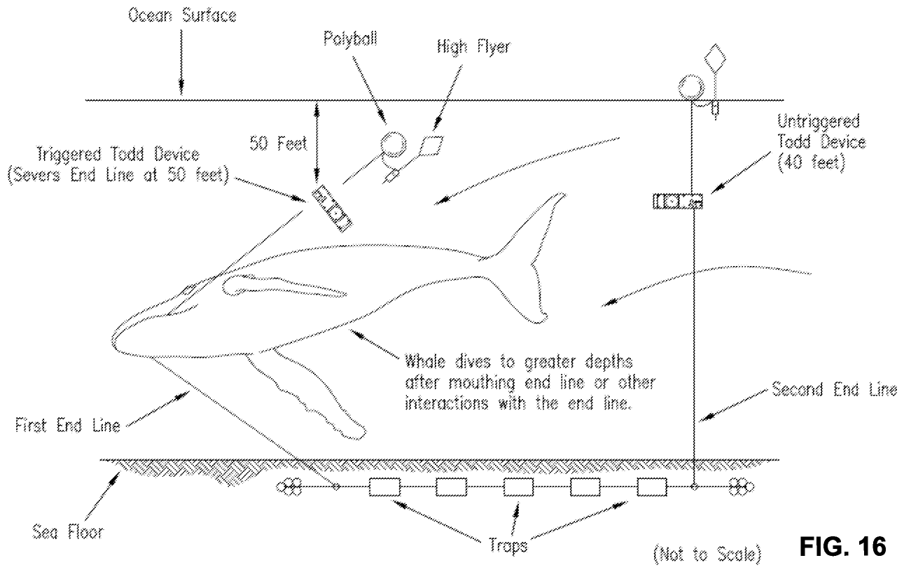

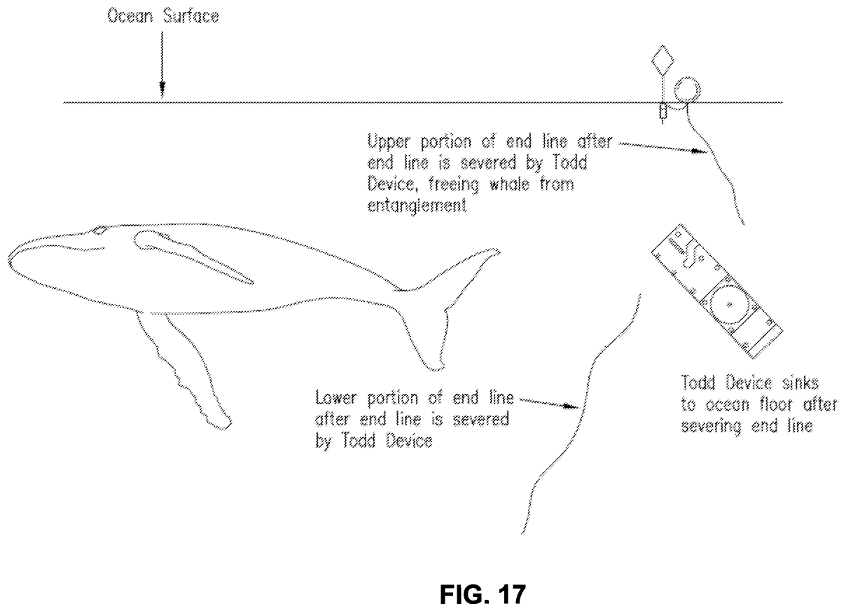

When a whale (or any other large marine animal), encounters an end line in the water column, and that contact results in the end line being lowered in the water column by approximately five vertical feet the trigger assembly affixed to the top of the cutter assembly of the Todd Device triggers the pin inside the trigger assembly, which simultaneously releases the blade, which, in turn, instantly slices through the end line passing through the aperture in the Todd Device, thus avoiding entanglement of the whale. See FIGS. 16 and 17. Essentially, the whale pulling the end line deeper into the water column triggers the release/cutting mechanism and eliminates the possibility of entanglement. The severing of the end line releases the tension between the traps on the ocean floor and the surface gear, thus creating a “dental floss” phenomenon, whereby the end line which may be caught or snagged in the mouth or on a flipper or the tail of the whale, is effectively allowed to slide out of whatever location on the whale to which it is attached. Disconnecting the traps on the ocean floor from the surface gear allows the whale to swim free without entanglement. Because the line “disconnect” is almost immediate, if not simultaneous, the whale does not have time to become further entangled.

The Todd Device 1 is “user friendly” in application, i.e., it is not complex, completely safe, and so uncomplicated as to be completely integrated with modern fishing practices. Further still, the Todd Device 1 requires very little additional time to use while lobster or crab fishing. The Todd Device 1 is not anticipated to be very expensive, and should last at least two years in a salt water environment before replacement becomes necessary. It is also anticipated that embodiments of the device will be used in connection with fishing for other sea creatures besides lobsters and crabs. Embodiments of the present invention may be used in any situation involving end lines connected to traps, or any other heavy equipment on the seabed, where those end lines pose a risk to large marine animals

In some embodiments, the trigger assembly 10 may be constructed primarily from stainless steel, not including the plug 70 and the O-ring 68, which are typically constructed from rubber or plastic material having an acceptable resistance to corrosion from being in salt water. The cutter assembly 5 may be constructed from stainless steel (screws and bolts and nuts) and any molded and rigid polymer material, such as marine grade high-density polyethylene (HDPE), with acceptable resistance to corrosion or degradation in salt water.

In preferred embodiments, the trigger assembly is removably attached to the cutter assembly so that various sizes and configurations of trigger assemblies may be attached to the same cutter assembly, depending on the circumstances where the device will be deployed. This would permit, for example, suppliers to purchase and stock separate inventories of trigger assemblies and cutter assemblies, and then assemble Todd Devices with differing activation thresholds, depending on the demand.

While the present invention has been disclosed with reference to certain embodiments, numerous modifications, alterations and changes to the disclosed embodiments are possible without departing from the scope of the present invention, as defined in the appended claims. Accordingly, it is intended that the present invention not be limited to the described embodiments, but that it has the full scope defined by the language of the following claims, and equivalents thereof.

1. A device for automatically severing a rope line that ties a marker floating on or near a surface of a body of water to underwater fishing gear located below the surface of the body of water, the device comprising:
a cutter assembly comprising an aperture, a rope line latch to fixedly secure a section of the rope line inside the aperture, and a spring-loaded blade assembly, the spring-loaded blade assembly comprising a blade, a blade holder that holds the blade in a position that is directly adjacent to the aperture, a set of loaded springs connected to the blade holder, the set of loaded springs being configured to urge the blade holder and the blade to move in a direction that causes the blade held by the blade holder to pass through the aperture if the load on the set of loaded springs is released, a receiving slot in the blade holder, the receiving slot being configured to receive a first end of a piston rod that, while inserted in the receiving slot prevents movement of the blade holder in said direction and prevents said release of the load on said set of loaded springs;
a rope latch pin operable to (i) move the rope line latch into a closed and locked position across the aperture to fixedly secure the section of the rope line inside the aperture, and (ii) move the rope line latch into an open and unlocked position next to the aperture to release the section of the rope line from the aperture; and
a trigger assembly, attached to the cutter assembly, the trigger assembly comprising a cylinder and a piston, the piston comprising the piston rod and a piston skirt disposed within an internal chamber of the cylinder, the piston skirt being connected to an opposite end of the piston rod;
wherein, if the device passes below a predefined depth in the body of water, a resulting increase in water pressure on the internal chamber of the cylinder will force the piston skirt and the opposite end of the piston rod connected to the piston skirt to move away from the cutter assembly, thereby pulling the first end of the piston rod out of the receiving slot in the blade holder and releasing the load on the set of loaded springs;
whereby the releasing of the load on the set of loaded springs immediately causes the blade holder and the blade to move in the direction that causes the blade held by the blade holder to pass through the aperture and sever the section of the rope line secured in the aperture by the rope latch.

2. The device of claim 1, wherein the internal chamber of the cylinder is configured to have a cross-sectional size that is selected so that the increase in water pressure on the internal chamber will cause the piston skirt to pull the first end of the piston rod out of the receiving slot in the cutter assembly when the device passes below the predefined depth in the body of water.

3. The device of claim 1, wherein the load in the set of loaded springs is imparted by compressing a set of coils in the set of loaded springs.

4. The device of claim 1, wherein the load in the set of loaded springs is imparted by stretching a set of coils in the set of loaded springs.

5. The device of claim 1, wherein the set of loaded springs comprises two or more banks of loaded springs.

6. The device of claim 1, wherein the set of loaded springs comprises an inner loaded spring nested inside an outer loaded spring.

7. The device of claim 6, wherein the inner loaded spring has a first central axis that is coextensive with a second central axis of the outer loaded spring.

8. (canceled)

9. The device of claim 1, wherein the underwater fishing gear comprises one or more lobster traps or one or more crab traps.

10. The device of claim 9, wherein the rope line comprises an end line for said one or more lobster traps or said one or more crab traps.

11. The device of claim 1, wherein the marker floating on the surface of the body of water comprises a high flyer or a polyball.

12. The device of claim 1, wherein the predefined depth is between 30 and 50 feet below the surface of the body of water.

13. The device of claim 1, wherein the predefined depth is between 50 and 100 feet below the surface of the body of water.

14. The device of claim 1, wherein the predefined depth is between 100 and 200 feet below the surface of the body of water.

15. The device of claim 1, wherein the predefined depth between 200 and 400 feet below the surface of the body of water.

16. The device of claim 1, wherein the trigger assembly is configured to pull the first end of the piston rod out of the receiving slot of the cutter assembly if the water pressure exerted on the internal chamber of the cylinder exceeds a predefined pressure threshold.

17. The device of claim 16, wherein the predefined pressure threshold is between 25 and 30 psi.

18. The device of claim 16, wherein the predefined pressure threshold is between 35 and 40 psi.

19. The device of claim 16, wherein the predefined pressure threshold is between 60 and 70 psi.

20. The device of claim 1, wherein the cutter assembly further comprises:
a top clamshell; and
a bottom clamshell;
wherein the top clamshell and the bottom clamshell are bolted, screwed or glued together to define an airtight enclosure that encapsulates the spring-loaded blade assembly.

21. The device of claim 1, wherein the trigger assembly is removably attached to the cutter assembly.
